(19) United States
(12) Patent Application Publication
(10) Pub. No.: US 2021/0363026 A1
(43) Pub. Date: Nov. 25, 2021

(54) INDIUM TIN OXIDE PARTICLE, INDIUM TIN OXIDE PARTICLE DISPERSION, CURABLE COMPOSITION, OPTICAL MEMBER, LENS UNIT, METHOD FOR PRODUCING INDIUM TIN OXIDE PARTICLE, AND METHOD FOR PRODUCING CURABLE COMPOSITION

(71) Applicant: FUJIFILM CORPORATION, Tokyo (JP)

(72) Inventor: Masahiro TAKATA, Kanagawa (JP)

(21) Appl. No.: 17/317,927

(22) Filed: May 12, 2021

(30) Foreign Application Priority Data
May 20, 2020 (JP) 2020-088245

(51) Int. Cl. C01G 19/02; C08F 2/44; C08F 2/46; C08F 20/14; C08K 3/22; G02B 1/04

(52) U.S. Cl. CPC C01G 19/02; C08F 2/44; C08F 2/46; C08F 20/14; B82Y 30/00; G02B 1/041; C01P 2004/64; C01P 2004/04; C08K 3/22

(57) ABSTRACT

Provided are an indium tin oxide particle which has absorption in the near infrared region at a wavelength of 1800 nm or less, has high dispersibility, and has good plasmon resonance absorption; an indium tin oxide particle dispersion; a curable composition; an optical member; a lens unit; a method for producing indium tin oxide particles; and a method for producing a curable composition. Provided are an indium tin oxide particle, in which, in an X-ray photoelectron spectroscopy spectrum, an oxygen amount O_{A} attributed to a peak having a peak top at a position of 530.0±0.5 eV and an oxygen amount O_{B} attributed to a peak having a peak top at a position of 531.5±0.5 eV satisfy the following expression 1; a curable composition; and applications thereof.

O_{A}/O_{B}>1.4: Expression 1

### CROSS-REFERENCE TO RELATED APPLICATIONS

This application claims priority from Japanese Patent Application No. 2020-088245, filed May 20, 2020, the disclosure of which is incorporated herein by reference in its entirety.

### BACKGROUND OF THE INVENTION

### 1. Field of the Invention

The present disclosure relates to an indium tin oxide particle, an indium tin oxide particle dispersion, a curable composition, an optical member, a lens unit, a method for producing indium tin oxide particles, and a method for producing a curable composition.

### 2. Description of the Related Art

Indium tin oxide (hereinafter, also referred to as “ITO”) particles have come to be used for various uses. Among these, ITO particles having a high absorbance in a near infrared region are useful for forming optical members such as a diffraction grating lens and an infrared filter, and it is possible to realize a cured product including the ITO particles and having good transparency.

Therefore, various ITO particles having absorption in a near infrared region at a wavelength of 1800 nm or less, having high dispersibility, and having good plasmon resonance absorption, and methods for producing the ITO particles have been studied.

As a producing method focusing on physical properties of ITO, for example, as ITO suitable for an organic electroluminescence (EL) element, a method for producing an organic EL element, in which the organic EL element having good brightness life is obtained by surface-treating a lower electrode layer, which consists of ITO of the organic EL element, to reduce the amount of a carbonyl compound present on the surface of the ITO particles to a specified amount or less, is disclosed (see JP2004-139746A). According to JP2004-139746A, in the lower electrode layer consisting of ITO, it is disclosed that (P2/P1), which is a ratio of a C═O-derived carbonyl peak (P2) appearing at 532 eV of X-ray photoelectron spectroscopy spectrum (XPS) to an In₂O₃-derived oxygen peak (P1) appearing at 530 eV, is set to 0.43 or less.

Regarding the method for producing ITO particles, for example, a method for producing ITO nanoparticles, in which a solution including a metal carboxylate is added dropwise to oleyl alcohol heated to 100° C. to 290° C., has been proposed (for example, see U.S. Pat. No. 9,517,945B).

Furthermore, the present inventor has previously proposed, as a more efficient method for producing ITO particles, a method for producing indium tin oxide particles, the method including: heating an indium carboxylate and a tin carboxylate in a solvent including a carboxylic acid; obtaining a reaction solution including indium tin oxide particles by adding dropwise, at a dropping rate of 1.0 mL/min or more, the obtained precursor solution to a solvent having a hydroxyl group and having 14 to 22 carbon atoms; and after a completion of the dropwise addition of the precursor solution, retaining the obtained reaction solution under a temperature condition of 230° C. to 320° C. for 60 minutes to 180 minutes (see WO2019/172151A).

### SUMMARY OF THE INVENTION

JP2004-139746A discloses an invention in line with the problem of improving the luminance life of ITO used for an electrode of the organic EL element, but there is no focus on ITO particles having good plasmon resonance absorption and physical properties thereof.

In addition, in the invention disclosed in U.S. Pat. No. 9,517,945B, in a case where oleyl alcohol is used alone as a solvent of adding dropwise the solution including a metal carboxylate to the solvent, depending on the conditions such as the dropping rate, carrier generation efficiency tends to decrease, and the plasmon absorption tends to be a long wavelength. The phenomenon in which the plasmon absorption is a long wavelength is an important problem to be solved in optical member applications in which it is required to selectively have optical absorption in the near infrared region.

In light of these problems, there is a high demand for a material capable of obtaining high absorbance in the near infrared region at a wavelength of 1800 nm or less.

In the invention disclosed in WO2019/172151A, ITO particles capable of obtaining high absorbance in the near infrared region at a wavelength of 1800 nm or less can be efficiently produced. However, WO2019/172151A does not focus on the physical properties of oxygen atoms included in ITO particles. In addition, from the viewpoint of producing method, since the producing method disclosed in WO2019/172151A requires a step of holding the obtained reactant for a predetermined time, further improvement suitable for practical use is desired.

An object to be achieved by an embodiment of the present disclosure is to provide an indium tin oxide particle which has absorption in the near infrared region at a wavelength of 1800 nm or less, has high dispersibility, and has good plasmon resonance absorption; an indium tin oxide particle dispersion; a curable composition including indium tin oxide particles; an optical member; and a lens unit.

An object to be achieved by another embodiment of the present disclosure is to provide a method for producing an indium tin oxide particle which has absorption in the near infrared region at a wavelength of 1800 nm or less, has high dispersibility, and has good plasmon resonance absorption; and a method for producing a curable composition including indium tin oxide particles.

The specific methods for achieving the objects include the following aspects.

<1> An indium tin oxide particle,
in which, in an X-ray photoelectron spectroscopy spectrum, an oxygen amount O_{A} attributed to a peak having a peak top at a position of 530.0±0.5 eV and an oxygen amount O_{B} attributed to a peak having a peak top at a position of 531.5±0.5 eV satisfy the following expression 1,

O_{A}/O_{B}>1.4: Expression 1.

<2> An indium tin oxide particle dispersion comprising:
the indium tin oxide particle according to <1>; and
a non-polar solvent.

<3> A curable composition comprising:
the indium tin oxide particle according to <1>; and
a polymerizable compound.

<4> The curable composition according to <3>,
in which the polymerizable compound includes at least one selected from the group consisting of a monomer unit derived from acrylic acid and a monomer unit derived from methacrylic acid.

<5> An optical member which is a cured product of the curable composition according to <3> or <4>.

<6> A lens unit comprising:
the optical member according to <5>.

<7> A method for producing indium tin oxide particles, the method comprising:
a step of obtaining a precursor solution including indium and tin by heating a mixed solution including indium carboxylate having 1 to 3 carbon atoms, tin carboxylate having 1 to 3 carbon atoms, and a solvent including a carboxylic acid having 6 to 20 carbon atoms, within a range in which a total amount A mol of indium and tin included in the indium carboxylate and the tin carboxylate, and a content B mol of the carboxylic acid included in the solvent satisfy the following expression 2; and
a step of obtaining a reaction solution including indium tin oxide particles by adding dropwise the obtained precursor solution to a heated solvent having a hydroxyl group and having 14 to 22 carbon atoms,

B/A<5: Expression 2.

<8> The method for producing indium tin oxide particles according to <7>,
in which the total amount A mol of indium and tin included in the indium carboxylate and the tin carboxylate, and the content B mol of the carboxylic acid included in the solvent satisfy the following expression 3,

3<B/A: Expression 3.

<9> The method for producing indium tin oxide particles according to <7> or <8>,
in which, in the step of obtaining the reaction solution including the indium tin oxide particles, the precursor solution is added dropwise at a dropping rate of 1.0 mL/min or more.

<10> The method for producing indium tin oxide particles according to any one of <7> to <9>,
in which the carboxylic acid having 6 to 20 carbon atoms includes oleic acid.

<11> The method for producing indium tin oxide particles according to any one of <7> to <10>,
in which the solvent having a hydroxyl group and having 14 to 22 carbon atoms includes oleyl alcohol.

<12> The method for producing indium tin oxide particles according to any one of <7> to <11>,
in which a temperature of the heated solvent having a hydroxyl group and having 14 to 22 carbon atoms is 230° C. to 320° C.

<13> The method for producing indium tin oxide particles according to any one of <7> to <12>,
in which a total content C mol of the solvent having a hydroxyl group and having 14 to 22 carbon atoms, and a content D mol of the carboxylic acid having 6 to 20 carbon atoms satisfy the following expression 4,

D/(C+D)<0.5: Expression 4.

<14> A method for producing a curable composition, the method comprising:
a step of obtaining indium tin oxide particles by the method for producing indium tin oxide particles according to any one of <7> to <13>; and
a step of obtaining a curable composition having absorption in a near infrared region by mixing the obtained indium tin oxide particles and a polymerizable compound.

According to the embodiment of the present disclosure, an indium tin oxide particle which has absorption in the near infrared region at a wavelength of 1800 nm or less, has high dispersibility, and has good plasmon resonance absorption; an indium tin oxide particle dispersion; a curable composition including indium tin oxide particles; an optical member; and a lens unit are provided.

According to another embodiment of the present disclosure, a method for producing an indium tin oxide particle which has absorption in the near infrared region at a wavelength of 1800 nm or less, has high dispersibility, and has good plasmon resonance absorption; and a method for producing a curable composition including indium tin oxide particles are provided.

### BRIEF DESCRIPTION OF THE DRAWINGS

FIG. 1 is a graph showing an X-ray photoelectron spectroscopy spectrum indicating, with regard to ITO particles obtained in Example 1, an oxygen amount O_{A} attributed to a peak having a peak top at a position of 530.0±0.5 eV, an oxygen amount O_{B} attributed to a peak having a peak top at a position of 531.5±0.5 eV, and an oxygen amount O_{C} attributed to a peak having a peak top at a position of 533.0±0.5 eV.

### DESCRIPTION OF THE PREFERRED EMBODIMENTS

Hereinafter, an indium tin oxide particle, an indium tin oxide particle dispersion, a curable composition, an optical member, a lens unit, a method for producing indium tin oxide particles, and a method for producing a curable composition according to an embodiment of the present disclosure will be described in detail. The description of constituent elements below is made based on representative embodiments of the present disclosure, but the present disclosure is not limited to the following embodiments.

In the present disclosure, a numerical range described by using “to” represents a numerical range including numerical values before and after “to” as a lower limit value and an upper limit value.

In a numerical range described in a stepwise manner in the present disclosure, an upper limit value or a lower limit value described in a certain numerical range may be replaced with an upper limit value or a lower limit value in another numerical range described in a stepwise manner.

In addition, a combination of two or more preferred aspects is a more preferred aspect.

In the present disclosure, in a case where a plurality of substances corresponding to each component in a composition is present, the amount of each component in the composition means the total amount of the plurality of substances present in the composition, unless otherwise specified.

In the present disclosure, the term “step” includes not only the independent step but also a step in which intended purposes are achieved even in a case where the step cannot be precisely distinguished from other steps.

A description for a group (atomic group) in the present disclosure is used in a meaning including an unsubstituted group and a group having a substituent, unless otherwise specified. For example, “alkyl group” is used in a meaning including both of an alkyl group (unsubstituted alkyl group) having no substituent and an alkyl group (substituted alkyl group) having a substituent. The same applies to other substituents.

In addition, in the present disclosure, “(meth)acrylic” represents both or either of acrylic and methacrylic, and “(meth)acrylate” represents both or either of acrylate and methacrylate.

The near infrared region in the present disclosure includes a wavelength region of 1000 nm to 1800 nm.

Indium Tin Oxide Particle

In the indium tin oxide particle according to the embodiment of the present disclosure, in an X-ray photoelectron spectroscopy spectrum, an oxygen amount O_{A} attributed to a peak having a peak top at a position of 530.0±0.5 eV and an oxygen amount O_{B} attributed to a peak having a peak top at a position of 531.5±0.5 eV satisfy the following expression 1.

O_{A}/O_{B}>1.4: Expression 1

Hereinafter, in the present disclosure, the X-ray photoelectron spectroscopy spectrum may be abbreviated as XPS.

The X-ray photoelectron spectroscopy spectrum evaluation of the indium tin oxide particles can be performed using an XPS analyzer. In the present disclosure, an XPS analyzer (manufactured by PHI, Quantera SXM: device name) is used to evaluate the bonding state of oxygen atoms on an outermost surface of ITO particles under the following conditions.

[Conditions]
X-ray source: monochromatic Al (1486.6 eV)
Detection depth: 4 nm to 5 nm (extraction angle: 45°)

As a method of peak separation, the oxygen amount O_{A} attributed to a peak having a peak top at a position of 530.0±0.5 eV and the oxygen amount O_{B} attributed to a peak having a peak top at a position of 531.5±0.5 eV are estimated by the area value of each peak in oxygen is spectrum.

The area value of each peak can be calculated by performing waveform separation by peak fitting of the oxygen is spectrum, and in the present disclosure, the value calculated by the above method is used.

Here, the oxygen attributed to the peak having a peak top at a position of 530.0±0.5 eV indicates the presence of oxygen atoms, in which both of the two bonds of the oxygen atom are bonded to a metal selected from indium and tin. Therefore, the oxygen amount O_{A} calculated from the area of the spectrum confirms the presence of oxygen atoms which are firmly bonded to the metal atoms in ITO particles.

On the other hand, the oxygen atom attributed to the peak having a peak top at a position of 531.5±0.5 eV indicates the presence of oxygen atoms, in which one bond of the oxygen is bonded to a metal selected from indium and tin, and the other bond is bonded to a hydrogen atom or an oxygen atom, that is, the other bond of the oxygen atom is bonded to a carboxylic acid, alcohol, and the like in a reaction solvent. Therefore, the oxygen amount O_{B} calculated from the area of the spectrum confirms the presence of oxygen atoms which are insufficiently bonded to the metal atoms in the ITO particles.

In addition, the oxygen attributed to the peak having a peak top at a position of 533.0±0.5 eV is oxygen in which two bonds of the oxygen atom are not bonded to a metal selected from indium and tin, and are bonded to two carbon atoms or constitute a carbonyl bond. The oxygen amount O_{C} calculated from the area of the spectrum in Examples described later means the presence of such oxygen.

According to the studies of the present inventor, in the oxygen atoms of ITO particles, it is found that, in a case where the oxygen amount O_{B} decreases relative to the oxygen amount O_{A}, the number of ITO particles which are easily nucleated and have more excellent dispersibility increases.

The ITO particles which are easily nucleated and have more excellent dispersibility are ITO particles in which the oxygen amount O_{A} and the oxygen amount O_{B} satisfy the following expression 1.

O_{A}/O_{B}>1.4: Expression 1

It is preferable that the oxygen amount O_{A} and the oxygen amount O_{B} satisfy the following expression 1-2.

O_{A}/O_{B}>1.5: Expression 1-2

In order to obtain ITO particles in which the oxygen amounts satisfy this requirement, it is preferable to apply the method for producing ITO particles according to the embodiment of the present disclosure described later.

Since the ITO particle according to the embodiment of the present disclosure has absorption in a near infrared region at a wavelength of 1800 nm or less, has high dispersibility, and has good plasmon resonance absorption, the ITO particle according to the embodiment of the present disclosure can be applied to various uses. Hereinafter, having absorption in the near infrared region may be referred to as “near infrared absorption”. The near infrared absorption can be confirmed by measuring the transmittance of wavelength in the near infrared absorption region. As the transmittance of wavelength in the near infrared absorption region is lower, the near infrared absorption is better.

Near Infrared Absorption

As a preferred near infrared absorption of the ITO particles, for example, in a case of measuring an absorbance by the following method, the absorbance at the absorption peak wavelength existing in the near infrared is preferably 0.2 or more and more preferably 0.3 or more.

The absorbance of the ITO particles in the near infrared region at a wavelength of 1800 nm or less can be measured, for example, using a spectrophotometer V-670 manufactured by JASCO Corporation.

In the present disclosure, an absorbance value of ITO particle dispersion adjusted to a concentration of 0.006% by mass, which is measured at an optical path length of 2 mm using the spectrophotometer V-670 manufactured by JASCO Corporation, is adopted.

The fact that the ITO particles have good plasmon resonance absorption can be confirmed, for example, by measuring absorption spectrum using a spectrophotometer V-670 manufactured by JASCO Corporation. That is, it is a method of performing absorption spectrum measurement and confirming the presence of clear plasmon resonance absorption peak in the vicinity of a wavelength of 1800 nm.

Particle Size of Indium Tin Oxide Particles

The number-average particle size of the ITO particles according to the embodiment of the present disclosure is preferably 10 nm to 30 nm, more preferably 15 nm to 25 nm, and still more preferably 20 nm to 25 nm.

By setting the number-average particle size within the above-described range, in a case where the ITO particles are blended into a dispersion described later, a curable composition, and the like, scattering in a visible light region is suppressed and an increase in viscosity of the composition is easily suppressed. By suppressing the increase in viscosity of the composition, the particles can be dispersed in a higher concentration, and as a result, it is possible to obtain a dispersion having a lower visible light transmittance, a curable composition having a lower Abbe number, and the like.

The number-average particle size can be obtained by observing the particles with a transmission electron microscope (TEM), calculating an equivalent circular size of 100 particles, and calculating an arithmetic average value thereof.

In addition, from the viewpoint of controlling the resonance peak sharply, it is preferable that the standard deviation of the number-average particle size is 5 nm or less, and it is more preferable that the standard deviation of the number-average particle size is 3 nm or less.

The standard deviation can be obtained by observing the particles with a transmission electron microscope (TEM), calculating an equivalent circular size of 100 particles, and calculating a standard deviation thereof

Indium Tin Oxide Particle Dispersion

The above-described indium tin oxide particles according to the embodiment of the present disclosure can exist in a state of a dispersion.

The indium tin oxide particle dispersion according to the embodiment of the present disclosure includes the above-described indium tin oxide particles according to the embodiment of the present disclosure, and a non-polar solvent.

The non-polar solvent is a solvent having a relatively small relative permittivity value, that is, a so-called solvent not having polarity. Examples of the non-polar solvent include aromatic hydrocarbon solvents having 6 to 30 carbon atoms, such as n-hexane, n-decane, dodecane, tetradecane, and hexadecane; solvents in which the aliphatic hydrocarbon solvent is substituted with fluorine, such as fluorocarbon oil; aromatic hydrocarbon solvents such as toluene; and silicone solvents such as silicone oil.

Examples of a non-polar solvent suitable for the ITO particle dispersion according to the embodiment of the present disclosure include toluene, hexane, octane, benzene, cyclohexane, 1,4-dioxane, diethyl ether, chloroform, and chlorobenzene.

Among these, from the viewpoint of better dispersibility of the ITO particles, toluene or hexane is suitable.

For example, even in a case where the dispersion of the ITO particles according to the embodiment of the present disclosure is mixed with a polymerizable compound and applied to a curable composition, toluene and hexane, which are non-polar solvents having better dispersibility of ITO particles, also have an advantage that they can be easily removed in a case of being mixed with the polymerizable compound.

The ITO particle dispersion is formed by dispersing the above-described ITO particles according to the embodiment of the present disclosure in the non-polar solvent.

The content of the ITO particles in the ITO particle dispersion is appropriately selected depending on the use of the ITO particle dispersion. The content of the non-polar solvent in the ITO particle dispersion is also appropriately selected depending on the use of the ITO particle dispersion.

For example, in a case where the ITO particle dispersion is applied to a curable composition or the like described later, the content of the ITO particles with respect to the total amount of the ITO particle dispersion is preferably 1% by mass to 10% by mass and more preferably 2% by mass to 8% by mass.

In a case where the content of the ITO particles in the ITO particle dispersion is within the above-described range, it has advantages such as better particle dispersibility, easier removal of non-polar solvent in a case of being mixed with a polymerizable compound, and easier scale in the preparation of the curable composition.

The ITO particle dispersion can include other components in addition to the ITO particles and the non-polar solvent. Examples of other components include a dispersant of ITO particles and a viscosity adjuster.

Since the above-described ITO particles according to the embodiment of the present disclosure have good dispersibility in the non-polar solvent, the dispersant is not particularly required, but a known dispersant may be used depending on the purpose.

The method for producing the ITO particle dispersion is not particularly limited. For example, the ITO particle dispersion can be produced by taking out, from the reaction solvent, ITO particles obtained by the method for producing ITO particles described later, and mixing the obtained ITO particles with a non-polar solvent.

The ITO particles used in the dispersion may be purified by a method of taking out the ITO particles from a reaction solution, washing if necessary, redispersing in a solvent, and then separating again.

Since the ITO particle dispersion according to the embodiment of the present disclosure has good dispersibility of ITO particles, the ITO particle dispersion can be applied to various uses as it is. Examples of applicable uses of the dispersion include uses in which the ITO particle dispersion is applied to a substrate to form an ITO-particle-containing film.

Preferred physical properties of the dispersion according to the embodiment of the present disclosure will be shown below.

The dispersibility of the ITO particles according to the embodiment of the present disclosure can be evaluated by the transparency of the dispersion including the ITO particles. In a case where the dispersibility of ITO particles in the dispersion is good and the formation of aggregates of ITO particles is suppressed, the dispersion has a low haze and good linear transmittance of visible light.

Haze

To measure the haze, the ITO particle dispersion is dried to remove the non-polar solvent, and the concentration [% by mass] of solid contents of the dispersion is obtained. Thereafter, a dispersion obtained by diluting the concentration of solid contents of the dispersion system to 0.6% by mass is prepared and used as a solution to be measured.

A spectroscopic haze meter (manufactured by NIPPON DENSHOKU INDUSTRIES Co., Ltd., SH7000) is used to evaluate the haze value of the obtained solution to be measured.

From the viewpoint of dispersibility, the haze is preferably 1.0 or less and more preferably 0.8 or less.

Linear Transmittance of Visible Light

The linear transmittance of visible light can be measured using a spectrophotometer V-670 manufactured by JASCO Corporation with the above-described solution to be measured as a measurement target.

In the present disclosure, the linear transmittance at wavelengths of 360 nm, 380 nm, and 400 nm is measured as visible light to evaluate the linear transmittance of visible light.

The linear transmittance at a wavelength of 360 nm is preferably 65% or more and more preferably 70% or more.

The linear transmittance at a wavelength of 380 nm is preferably 79% or more and more preferably 80% or more.

The linear transmittance at a wavelength of 400 nm is preferably 84% or more and more preferably 85% or more.

Curable Composition

The curable composition according to the embodiment of the present disclosure includes the above-described indium tin oxide particle (ITO particle) according to the embodiment of the present disclosure, and a polymerizable compound.

By containing the ITO particles according to the embodiment of the present disclosure in a curable composition to form a cured product, the ITO particles according to the embodiment of the present disclosure can be used for various uses such as being applied to an optical member as an optical material.

The curable composition according to the embodiment of the present disclosure is a composition cured by applying energy from the outside, preferably a composition cured by heat or light, and more preferably a composition cured by light.

The method for producing the curable composition according to the embodiment of the present disclosure will be described later.

As described above, since the ITO particles according to the embodiment of the present disclosure has a peak wavelength of a plasmon resonance absorption in the near infrared region (for example, a wavelength near 1900 nm), a curable composition having a low Abbe number can be realized, which leads to improvement in performance in a case of being used as an optical member such as a diffraction grating lens described later and improvement in degree of freedom in a case of designing an optical element.

The amount of the ITO particles used in the curable composition according to the embodiment of the present disclosure may be selected depending on the use of the curable composition. Considering the curability of the composition and the expressiveness of characteristics of the ITO particles, the amount of the ITO particles in the curable composition is preferably 18% by mass or more, more preferably 38% by mass or more, and still more preferably 43% by mass or more with respect to the total solid content of the composition.

In addition, the content with respect to the total solid content of the composition is preferably 80% by mass or less, more preferably 75% by mass or less, and still more preferably 70% by mass or less.

In the present specification, the “total solid content” refers to the total amount of components in the composition, excluding volatile components such as a solvent.

The content of the ITO particles in the curable composition can be calculated, in a case where the composition is subjected to a thermal mass spectrometry and remaining solid components after heating to a temperature (for example, 500° C.) at which liquid components can be completely removed are regarded as ITO particles, as a mass content of the ITO particles with respect to the total solid content of the curable composition to be measured.

Polymerizable Compound

The curable composition according to the embodiment of the present disclosure includes a polymerizable compound.

The polymerizable compound is not particularly limited as long as the polymerizable compound is a compound which can be polymerized and cured. As the polymerizable compound, a radically polymerizable compound is preferable, and an ethylenic unsaturated compound having at least one ethylenic unsaturated group in the molecule is more preferable.

Among these, from the viewpoint that it is easy to form a cured product which gives suitable light-transmitting property to the optical member, it is preferable that the polymerizable compound includes at least one selected from the group consisting of a monomer unit derived from acrylic acid and a monomer unit derived from methacrylic acid.

Specifically, as the ethylenic unsaturated compound, from the viewpoint of easily setting the refractive index of the curable composition after curing to approximately 1.5 to 1.55, which is a suitable value for use, for example, in a diffraction grating lens, a polyfunctional ethylenic unsaturated compound having two or more ethylenic unsaturated groups is preferable, and a polyfunctional (meth)acrylate compound having two or more (meth)acryloxy groups is more preferable. Examples of the polyfunctional ethylenic unsaturated compound include 1,4-divinylcyclohexane, 1,4-cyclohexanedimethanol divinyl ether, divinylbenzene, 1,6-divinylnaphthalene, ethoxylated bisphenol A divinyl ether, propoxylated bisphenol A di(meth)acrylate; polyethylene glycol di(meth)acrylate, polypropylene glycol di(meth)acrylate, trimethylolethane tri(meth)acrylate, neopentyl glycol di(meth)acrylate, pentaerythritol tri(meth)acrylate, pentaerythritol tetra(meth)acrylate, dipentaerythritol hexa(meth)acrylate, hexanediol di(meth)acrylate, tricyclodecane dimethanol diacrylate, tri(acryloyloroxyethyl) isocyanurate, tris(2-acryloyloxyethyl) isocyanurate, and compounds similar to these compounds.

The curable composition may contain one kind of polymerizable compound or may contain two or more kinds thereof.

The content of the polymerizable compound in the curable composition is preferably 15% by mass to 85% by mass, more preferably 20% by mass to 70% by mass, and still more preferably 30% by mass to 60% by mass with respect to the total solid content of the curable composition.

The curable composition according to the embodiment of the present disclosure may include other components depending on the purpose, in addition to the ITO particles according to the embodiment of the present disclosure and the polymerizable compound. Examples of preferred other components include a polymerization initiator and a dispersant.

Polymerization Initiator

The curable composition according to the embodiment of the present disclosure preferably contains a polymerization initiator.

From the viewpoint that the curable composition is an ultraviolet curing-type curable composition, it is preferable to contain a photopolymerization initiator as the polymerization initiator.

The polymerization initiator can be appropriately selected depending on the polymerizable compound contained in the curable composition. For example, in a case where the curable composition includes a radically polymerizable compound as the polymerizable compound, it is preferable that a polymerization initiator which can be included as desired is a radical polymerization initiator.

Hereinafter, a photoradical polymerization initiator which is a preferred aspect as the polymerization initiator will be described.

As the photoradical polymerization initiator, a photoradical polymerization initiator including an acylphosphine oxide structure, an α-hydroxyalkylphenone structure, or an α-aminoalkylphenone structure is preferable.

The photoradical polymerization initiator is not particularly limited in structure, and examples thereof include 2,4,6-trimethylbenzoyldiphenylphosphine oxide, bis(2,4,6-trimethylbenzoyl)phenylphosphine oxide, 2,2-dimethoxy-1,2-diphenylethan-1-one, 1-hydroxycyclohexyl phenylketone, 1-hydroxycyclohexyl phenylketone, 1-[4-(2-hydroxyethoxy)phenyl]-2-hydroxy-2-methyl-1-propan-1-one, 2-hydroxy-1-{4-[4-(2-hydroxy-2-methyl-propionyl)benzyl]phenyl}-2-methyl-propan-1-one, and 2-methyl-1-(4-methylthiophenyl)-2-morpholinopropan-1-one.

A commercially available product may be used as the photoradical polymerization initiator, and specific examples of the commercially available product include IRGACURE (trademark) series manufactured by BASF (for examples, IRGACURE TPO, IRGACURE 819, IRGACURE 651, IRGACURE 184, IRGACURE 1173, IRGACURE 2959, IRGACURE 127, and IRGACURE 907).

In a case where the curable composition includes a polymerization initiator, the polymerization initiator may be included singly or in combination of two or more thereof.

From the viewpoint of wear resistance and high-temperature stretchability of a cured product obtained by using the curable composition, the content of the polymerization initiator in a case where the curable composition includes the polymerization initiator is preferably 0.05% by mass to 10% by mass, more preferably 0.1% by mass to 10% by mass, still more preferably 0.1% by mass to 5% by mass, and particularly preferably 0.5% by mass to 3% by mass with respect to the total mass of the polymerizable compound.

Dispersant

The curable composition may contain a dispersant.

By including the dispersant, dispersibility of the ITO particles in the polymerizable composition can be further increased, and as a result, the obtained curable composition easily achieves high visible light transmission characteristics, low Abbe number, and the like.

As the dispersant which can be included in the curable composition, a cationic surfactant, a nonionic surfactant, and an amphoteric surfactant are effective. In particular, as the surfactant, surfactants of polyester, ε-caprolactone, polycarboxylic acid salt, polyphosphoric acid salt, hydrostearic acid salt, amidosulfonic acid salt, polyacrylic acid salt, olefin-maleic acid salt copolymer, acryl-maleic acid salt copolymer, alkylamine acetate, organic phosphoric acids, alkyl fatty acid salt, fatty acid polyethylene glycol ester, silicone, and fluorine can be used, and among these, it is suitable to use at least one base dispersant selected from the group consisting of ammonia and organic amines.

Specific examples thereof include DISPERBYK series (manufactured by BYK Japan KK), Solsperse series (manufactured by Lubrizol Japan Ltd.), and TAMN series (manufactured by Nikko Chemicals Co., Ltd.). From the viewpoint that dispersibility is easily increased because of adsorbability to the ITO particles and steric hindrance, DISPERBYK-161 (amine type) or DISPERBYK-111 (phosphoric acid type) is more preferable.

In a case where the curable composition includes a dispersant, the dispersant may be included singly or in combination of two or more thereof.

The content of the dispersant in a case where the curable composition includes the dispersant is preferably 1% by mass to 30% by mass, more preferably 3% by mass to 20% by mass, and still more preferably 5% by mass to 15% by mass with respect to the total mass of ITO particles in the curable composition.

Components Other than Polymerization Initiator and Dispersant

The curable composition may contain other components other than the above-described preferred optional components, in addition to the polymerization initiator and the dispersant, which are the above-described preferred optional components.

Examples of the other components include a solvent, a polymerization inhibitor, a surfactant other than the above-described dispersant, a plasticizer, and a sensitizer. In the curable composition according to the embodiment of the present disclosure, in order to improve curability of the obtained curable composition and suppress the occurrence of non-uniformity inside the film during curing, it is preferable that the curable composition does not contain a solvent, or even in a case of containing a solvent, the content of the solvent is 1% by mass or less with respect to the total amount of the composition.

Characteristics of Curable Composition

Preferred characteristics of the curable composition according to the embodiment of the present disclosure will be shown below.

Abbe Number

The curable composition including the ITO particles according to the embodiment of the present disclosure can achieve a low Abbe number. From such a viewpoint, the Abbe number of the curable composition according to the embodiment of the present disclosure is preferably 8 to 30, more preferably 10 to 25, and still more preferably 10 to 20.

The Abbe number is a value calculated by the following expression 5.

Abbe number ν_{d}=(n_{d}−1)/(n_{f}−n_{c}): Expression 5

In the expression 5, n_{d} represents a refractive index for the D line (wavelength of 587.56 nm), n_{f} represents a refractive index for the F line (wavelength of 486.1 nm), and n_{c} represents a refractive index for the C line (wavelength of 656.3 nm), respectively.

The C line, D line, and F line are the C line, D line, and F line in the Fraunhofer line.

The Abbe number of the curable composition is measured using a refractometer DR-M2 manufactured by ATAGO CO., LTD.

Refractive Index

In the curable composition, the refractive index nD for light having a wavelength of 589 nm is preferably 1.40 to 1.60 and more preferably 1.40 to 1.55.

The refractive index is measured using a refractometer DR-M2 manufactured by ATAGO CO., LTD.

Visible Light Transmittance

In the curable composition according to the present disclosure, the visible light transmittance (hereinafter, sometimes simply referred to as “visible light transmittance”) at a wavelength of 405 nm is preferably 85% to 100% and more preferably 90% to 100%.

As the visible light transmittance in the present disclosure, a value measured using a spectrophotometer V-670 manufactured by JASCO Corporation, and in a case of being converted into an optical path length of 10 μm is adopted.

The use of the curable composition according to the embodiment of the present disclosure is not particularly limited, and can be widely applied to a cured product in which infrared absorption, visible light transmittance, and the like are required.

Resin Composition Including ITO Particles

In addition, the ITO particles according to the embodiment of the present disclosure can be applied to a resin composition including a polymer derived from a polymerizable compound and ITO particles.

That is, the above-described resin composition is a resin composition including a polymer derived from a polymerizable compound, instead of the polymerizable compound in the curable composition, and for example, a resin composition in which ITO particles are directly dispersed in a polymer (that is, a resin) can be obtained.

Examples of the polymer included in the resin composition include a polymer having at least one selected from the group consisting of a monomer unit derived from acrylic acid and a monomer unit derived from methacrylic acid.

As the polymer in the resin composition, known synthetic resins such as a (meth)acrylic resin, a polycarbonate resin, and a urethane resin can be used.

The resin composition may include other components depending on the purpose, in addition to the ITO particles and the polymer. Examples of other components include a solvent, a dispersant, a surfactant, and a viscosity adjuster.

Optical Member

The curable composition according to the embodiment of the present disclosure can be preferably used for an optical member which has a low Abbe number and in which a low refractive index is required.

The optical member according to the embodiment of the present disclosure is a cured product of the curable composition.

In a case of using a cured product of the above-described curable composition according to the embodiment of the present disclosure as an optical material, it is preferable that the curable composition is a composition having a low refractive index and a low Abbe number.

Examples of the optical member include a diffraction grating lens.

The use of the optical member is not limited thereto.

Examples of a method for obtaining an optical member using the curable composition according to the embodiment of the present disclosure as a cured product include a method in which a mold for forming an optical member such as a lens is filled with the curable composition and energy is applied thereto to cure the curable composition. Examples of the method of applying energy include heating, ultraviolet irradiation, and electron beam irradiation.

In addition, examples of the method for obtaining a cured product of the resin composition including ITO particles and the polymer include a method of melt-kneading and extruding the resin composition, and a method of filling a mold with a fluid resin composition including a solvent, reducing the content of the solvent by heating and the like, and then curing the resin composition for molding.

Lens Unit

Since the lens, which is the above-described optical member according to the embodiment of the present disclosure, has a low Abbe number and a low refractive index, the lens is suitable for a lens unit.

The lens unit according to the embodiment of the present disclosure includes the above-described optical member according to the embodiment of the present disclosure.

Examples of the lens unit include a unit in which the lens is incorporated into a lens barrel, a diffraction grating into which a diffraction grating lens is incorporated, and a microlens array.

The lens unit according to the embodiment of the present disclosure can be applied to various uses, for example, imaging units for a digital still camera, an in-vehicle lens, a security camera, and the like, and a sensing module.

Method for Producing Indium Tin Oxide Particles

The method for producing the above-described ITO particles according to the embodiment of the present disclosure is not particularly limited.

From the viewpoint that ITO particles having absorption in a near infrared region at a wavelength of 1800 nm or less, high dispersibility, and good plasmon resonance absorption can be efficiently produced, it is preferable that the ITO particles according to the embodiment of the present disclosure are obtained by the method for producing ITO particles according to the embodiment of the present disclosure described in detail below.

The method for producing indium tin oxide (ITO) particles according to the embodiment of the present disclosure is a method for producing indium tin oxide particles, the method including: a step (hereinafter, also referred to as a step (I)) of obtaining a precursor solution including indium and tin by heating a mixed solution including indium carboxylate having 1 to 3 carbon atoms, tin carboxylate having 1 to 3 carbon atoms, and a solvent including a carboxylic acid having 6 to 20 carbon atoms, within a range in which a total amount A mol of indium and tin included in the indium carboxylate and the tin carboxylate, and a content B mol of the carboxylic acid included in the solvent satisfy the following expression 2; and a step (hereinafter, also referred to as a step (II)) of obtaining a reaction solution including indium tin oxide particles by adding dropwise the obtained precursor solution to a heated solvent having a hydroxyl group and having 14 to 22 carbon atoms.

B/A<5: Expression 2

Furthermore, in the present disclosure, it is preferable that the total amount A mol of indium and tin included in the indium carboxylate and the tin carboxylate, and the content B mol of the carboxylic acid included in the solvent satisfy the following expression 3.

3<B/A: Expression 3

In the related art, shortening of plasmon absorption has been studied in order to selectively obtain optical absorption in the near infrared region. However, as in U.S. Pat. No. 9,517,945B, in a case where oleyl alcohol is used alone as a solvent in a case where a solution including a metal carboxylate is added dropwise to the solvent to form particles, depending on the conditions such as the dropping rate, carrier generation efficiency tends to decrease, and as a result, the plasmon absorption tends to be a long wavelength.

In the present disclosure, in a case of preparing the precursor solution in the step (I), by setting the ratio of the total amount of indium and tin included in the indium carboxylate and the tin carboxylate and the content of the carboxylic acid included in the solvent within an appropriate range, the physical properties of the obtained ITO particles are improved.

That is, in a case of preparing the precursor solution including indium and tin, by setting the content ratio of the carboxylic acid as a solvent to the amount of metal (In+Sn) in the mixed solution which is the reaction solution to be less than 5, it is presumed that the balance between solubility and reactivity of the metal in the mixed solution is improved, and fine particles having a carboxylic acid on the surface and having excellent dispersibility can be efficiently produced.

As a result, indium tin oxide particles having good dispersibility in the dispersion medium and exhibiting high absorbance in the near infrared region at a wavelength of 1800 nm or less can be obtained.

Step (I)

The step (I) is a step of obtaining a precursor solution including indium and tin by heating indium carboxylate (hereinafter, also simply referred to as indium carboxylate) having 1 to 3 carbon atoms and tin carboxylate (hereinafter, also simply referred to as tin carboxylate) having 1 to 3 carbon atoms in a solvent including a carboxylic acid having 6 to 20 carbon atoms.

As described in detail below, in a case of preparing the precursor solution, each component is blended in an amount such that the ratio (B/A) of the content B mol of the carboxylic acid in the solvent to the total content A mol of indium and tin included in the indium carboxylate and the tin carboxylate is less than 5.

Indium Raw Material and Tin Raw Material

As an indium raw material and a tin raw material used for preparing the precursor solution, an indium carboxylate having 1 to 3 carbon atoms and a tin carboxylate having 1 to 3 carbon atoms are used.

Specific examples of the indium raw material include indium formate, indium acetate, and indium propionate, and at least one indium carboxylate selected from the group consisting of these indium raw materials is used. Among these, from the viewpoint of stability, handleability, supply stability, and cost, indium acetate is preferable.

Examples of the tin raw material include tin (II) formate, tin (IV) formate, tin (II) acetate, tin (IV) acetate, tin (II) propionate, and tin (IV) propionate, and at least one tin carboxylate selected from the group consisting of these tin raw materials is used. Among these, from the viewpoint of stability, handleability, supply stability, and cost, tin (II) acetate or tin (IV) acetate is preferable, and tin (IV) acetate is more preferable.

By using the above-described indium raw material and tin raw material, the indium raw material and the tin raw material are easily dissolved in the solvent in a case of being heated in the solvent including a carboxylic acid having 6 to 20 carbon atoms. Therefore, it is possible to easily obtain a precursor solution in which the carboxylic acid having 6 to 20 carbon atoms is coordinated to indium and tin.

Among these, from the viewpoint of raw material cost, purity, stability, handleability, easiness of forming the precursor solution, and the like, it is preferable to use indium acetate and tin (IV) acetate as a preferred combination of the above-described indium raw material and the tin raw material.

Solvent Used for Preparing Precursor Solution

As the solvent for preparing the precursor solution, a solvent of an organic acid which includes a carboxylic acid having 6 to 20 carbon atoms is used.

The number of carbon atoms in the carboxylic acid is 6 to 20, preferably 14 to 20.

A hydrocarbon group in the carboxylic acid may be linear, may have a branch, or may have a ring structure as long as the hydrocarbon group has the above-described range of carbon atoms.

Among these, an unsaturated fatty acid is preferable as the carboxylic acid.

Specific examples of the solvent which includes a carboxylic acid having 6 to 20 carbon atoms include caproic acid, caprylic acid, pelargonic acid, 2-ethylhexanoic acid, capric acid, undecanoic acid, lauric acid, myristic acid, palmitic acid, stearic acid, palmitoleic acid, oleic acid, linoleic acid, and linolenic acid. Among these, it is preferable to use one or more organic acids selected from the group consisting of the above-described organic acids, it is more preferable to use one or more organic acids selected from the group consisting of caproic acid, caprylic acid, oleic acid, linoleic acid, and linolenic acid as the solvent, and it is still more preferable to include oleic acid.

The above-described content B mol of the carboxylic acid is the total content of a plurality of types of carboxylic acids. Commercially available carboxylic acids are often supplied as a mixture of carboxylic acids having multiple carbon chain lengths. In this case, the total amount of carboxylic acids included in the above-described mixture and having 6 to 20 carbon atoms is defined as B mol.

Any of the above-mentioned solvents can easily dissolve, by heating, the indium carboxylate having 1 to 3 carbon atoms and tin carboxylate having 1 to 3 carbon atoms, which are the above-described indium raw material and tin raw material, and by the dissolving, it is possible to easily obtain a precursor solution in which the carboxylic acid having 6 to 20 carbon atoms is coordinated to indium and tin respectively.

Preparation of Precursor Solution

The precursor solution is prepared by mixing the indium carboxylate having 1 to 3 carbon atoms and the tin carboxylate having 1 to 3 carbon atoms, and the solvent which includes a carboxylic acid having 6 to 20 carbon atoms, and heating the mixture.

The indium carboxylate and the tin carboxylate are dissolved by heating, and a solution of a precursor in which the carboxylic acid having 6 to 20 carbon atoms is coordinated (for example, in a case of using oleic acid, indium oleate and tin oleate) can be obtained.

In a case of preparing the precursor solution, the total content A mol of indium and tin included in the indium carboxylate and the tin carboxylate, and the content B mol of the carboxylic acid included in the solvent are adjusted within the range satisfying the following expression 2. In a case where B/A satisfies the expression 2, the reactivity is improved, and ITO particles having a carboxylic acid on the surface and having good dispersibility can be efficiently obtained.

B/A<5: Expression 2

B/A is less than 5, and is preferably 4.7 or less and more preferably 4.5 or less.

In addition, in the step (I), it is preferable that the total amount A mol of indium and tin included in the indium carboxylate and the tin carboxylate, and the content B mol of the carboxylic acid included in the solvent are in the range satisfying the following expression 3.

3<B/A: Expression 3

In a case where B/A is in the range of more than 3, solubility of indium and tin in the precursor solution is improved, and the reactivity is further improved.

B/A is preferably more than 3, more preferably 3.3 or more, and still more preferably 3.5 or more.

The above-described value of B/A can be obtained by calculating the number of moles from the amounts of indium carboxylate, tin carboxylate, and carboxylic acid used in the preparation of the precursor solution in the step (I) and the respective molecular weights.

In the step (I), it is preferable that the amount of the indium carboxylate and the tin carboxylate is used such that the amount of tin with respect to the total amount of indium and tin ([Sn/(In+Sn)]) is 0.05 to 0.15 in a molar ratio.

That is, it is preferable that the amount of the indium raw material and the tin raw material is weighed and mixed such that the amount of tin with respect to the total amount of indium and tin ([Sn/(In+Sn)]) is 0.05 to 0.15 in a molar ratio.

By including indium and tin in the above-described molar ratio range, it is easy to obtain ITO particles which can be suitably used for use of optical material such as an optical filter and an optical lens and has a plasmon resonance peak of approximately 1900 nm or less, preferably approximately 1800 nm or less.

The total molar concentration of metals included in the precursor solution is preferably 0.1 mmol (millimole)/mL or more and more preferably 0.3 mmol/mL or more.

By setting the molar concentration of metals within the above-described range, the yield of ITO particles can be easily increased.

The upper limit of the total molar concentration of metals included in the precursor solution is not particularly limited, but from the viewpoint of better solubility, the total molar concentration of metals included in the precursor solution can be set to 5 mmol/mL or less.

The heating temperature and heating time in a case of preparing the precursor solution are appropriately selected depending on the kinds of the indium carboxylate, the tin carboxylate, and the solvent which includes a carboxylic acid having 6 to 20 carbon atoms to be used. For example, in a case where indium acetate and tin (IV) acetate are used as the raw materials, and oleic acid is used as the solvent, it is preferable to heat at a temperature having an upper limit of 140° C. to 160° C. for approximately 1 hour. Under the above-described conditions, a yellow transparent precursor solution can be obtained.

In a case of preparing the precursor solution, in order to prevent a reaction system from being mixed with impurities such as oxygen and water, the mixing of the raw materials is preferably performed in a glove box or the like in which the oxygen concentration and the moisture concentration are controlled. In addition, in a case of preparing the precursor solution by heating the raw materials and the solvent, it is preferable to flow an inert gas such as nitrogen.

The obtained precursor solution can be applied to the next step by being filled into a syringe. In a case of filling the precursor solution into the syringe, in order to avoid mixing of oxygen and water, the filling operation is preferably performed in a glove box or the like in which the oxygen concentration and the moisture concentration are controlled.

Examples of the controlled conditions of oxygen concentration and moisture concentration include conditions in which the oxygen concentration is 5 ppm or less and the moisture concentration is 1 ppm or less, but the controlled conditions are not limited thereto.

Step (II)

The step (II) is a step of obtaining a reaction solution including indium tin oxide particles by adding dropwise the precursor solution obtained in the above-described step (I) to a heated solvent having a hydroxyl group and having 14 to 22 carbon atoms.

Solvent

In the preparation of the reaction solution, a heated solvent having a hydroxyl group and having 14 to 22 carbon atoms is used. The solvent is selected from the viewpoint of stability at the reaction temperature.

Specific examples of the solvent having a hydroxyl group and having 14 to 22 carbon atoms include myristyl alcohol, stearyl alcohol, palmityl alcohol, behenyl alcohol, arachidyl alcohol, palmitoleyl alcohol, oleyl alcohol, linoleyl alcohol, and docosenol.

The synthetic solvent preferably includes one or more solvents selected from the group consisting of the above-described solvents. As the solvent, from the viewpoint that workability is good since the boiling point is sufficiently lower than the reaction temperature and the melting point is a temperature at which the solution is not solid in a case of being cooled to room temperature after the reaction, one or more solvents selected from the group consisting of palmitoleyl alcohol, oleyl alcohol, and linoleyl alcohol is more preferable, and it is still more preferable to include oleyl alcohol.

The solvent having a hydroxyl group and having 14 to 22 carbon atoms may be used singly or in combination of two or more kinds thereof.

In a case of using two or more kinds of solvents having a hydroxyl group, for example, it is also one of preferred aspects of using oleyl alcohol, which is a solvent having a hydroxyl group and having 18 carbon atoms, and alcohols having a linear structure and having carbon atoms smaller than that of the oleyl alcohol, such as tetradecanol, 1-hexadecanol, and 1-octadecanol in combination.

In the step (II), the above-described solvent having a hydroxyl group is heated, the solvent is maintained in a heated state, and the precursor solution in which the carboxylic acid is coordinated with indium and tin, which is obtained in the step (I), is added dropwise thereto.

As a result, ITO particles are formed in the reaction solution.

Regarding the action and effect in this case, Metal-OH is formed according to an esterification reaction with a hydroxyl group and a carboxylic acid, and a Metal-O-Metal bond is formed by further dehydration. Here, “Metal” represents a metal atom such as indium.

In order to proceed the dehydration reaction and improve the proportion of Metal-O-Metal bond in the ITO particles, it is effective to suppress the generation of unnecessary water in the system and to efficiently remove water from the system. Specifically, for example, it is preferable to perform methods such as lowering the concentration of carboxylic acid which is not coordinated with In and Sn in the precursor, and flowing an inert gas to discharge water to the outside of the system.

In a case of the reaction, the above-described solvent having a hydroxyl group is charged into a reaction vessel such as a three-neck flask and heated. In a case of charging the solvent into the reaction vessel, in order to avoid mixing of oxygen and water into the reaction system, the charging is preferably performed in a glove box or the like in which the oxygen concentration and the moisture concentration are controlled.

It is sufficient that the heating temperature of the solvent is appropriately selected from a temperature at which the dissolved state of the metal in the precursor solution is maintained and the reaction proceeds. Among these, from the viewpoint that the ITO particles are easily formed, the heating temperature of the solvent is preferably in a range of 230° C. to 320° C., more preferably 250° C. to 310° C., and still more preferably 270° C. to 300° C.

Synthesis

ITO particles are obtained by the reaction in the solvent, in which the precursor solution obtained in the step (I) is added dropwise to the preheated solvent having a hydroxyl group and having 14 to 22 carbon atoms.

The dropping rate can be appropriately adjusted depending on the types of the indium raw material and tin raw material used in the precursor solution to be used, the concentration of the precursor solution, and the like.

Among these, from the viewpoint that the ITO particles can be formed more efficiently, the dropping rate is preferably 1.0 mL/min or more, more preferably 1.10 mL/min or more, and still more preferably 1.15 mL/min or more.

In addition, the dropping rate has no particular upper limit, but from the viewpoint of facility cost, can be set to 100 mL/min or less.

In the above-described preferred aspect, by setting the dropping rate to 1.0 mL/min or more, for example, the amount of the precursor solution added dropwise can be set to 50 mL or more, and the ITO particles can be efficiently formed. The amount of the precursor solution added dropwise can be appropriately adjusted depending on composition of the precursor solution, the amount of the alcohol solvent to be used, and the like. The amount added dropwise is preferably 50 mL or more and more preferably 100 mL or more. In addition, from the viewpoint of facility cost, the amount added dropwise is preferably set to 5 L or less.

In this case, since water, free acetic acid, and the like are generated with the esterification reaction, it is preferable to flow an inert gas such as nitrogen into the reaction system to discharge water, acetic acid, and the like generated outside the system, from the viewpoint that the esterification reaction is more likely to proceed and the yield of ITO particles is further improved.

The flow rate of the inert gas such as nitrogen is appropriately adjusted depending on the reaction scale, the dropping rate, and the like. Since, in a case where the flow rate of the inert gas is too low, the acetic acid and the like cannot be sufficiently discharged to the outside of the system and bumping may occur in the reaction solution, it is preferable to set a flow rate capable of sufficiently removing the water, acetic acid, and the like.

In the reaction solution, it is preferable that the total content C mol of the solvent having a hydroxyl group and having 14 to 22 carbon atoms, and the content D mol of the carboxylic acid having 6 to 20 carbon atoms satisfy the following expression 4, and it is more preferable to satisfy the following expression 4-2.

D/(C+D)<0.5: Expression 4

D/(C+D)<0.46: Expression 4-2

By satisfying the condition of the expression 4, the esterification reaction is likely to proceed and the yield of ITO particles is improved.

In a case of the reaction, from the viewpoint that the yield of ITO particles is further improved, it is preferable to satisfy the following expression 4-3.

0.1<D/(C+D)<0.5: Expression 4-3

The above-described value of D/(C+D) can be obtained by calculating the number of moles from the amount of the carboxylic acid used in the preparation of the precursor solution in the step (I), the amount of the solvent having a hydroxyl group and having 14 to 22 carbon atoms, which is used in the step (II), and the respective molecular weights.

Same as the ITO particles according to the embodiment of the present disclosure, the number-average particle size of the ITO particles obtained by the producing method according to the embodiment of the present disclosure is preferably 10 nm to 30 nm, more preferably 15 nm to 25 nm, and still more preferably 20 nm to 25 nm.

According to the producing method of the present disclosure, ITO particles having good dispersibility and having a number-average particle size in the above-described range can be efficiently obtained.

In the ITO particles obtained by the producing method according to the embodiment of the present disclosure, in a case of being blended into a dispersion, a curable composition, and the like, scattering in a visible light region is suppressed and an increase in viscosity of the composition is easily suppressed. By suppressing the increase in viscosity of the composition, the particles can be dispersed in a higher concentration, and as a result, a curable composition having a lower Abbe number can be obtained.

The producing method according to the embodiment of the present disclosure may include other steps in addition to the above-described step (I) and step (II).

Examples of other steps include a step [step (III)] of, after a completion of the dropwise addition of the precursor solution in the step (II), retaining the obtained reaction solution under a heating condition, preferably under a temperature condition of 230° C. to 320° C., and a step [step (IV)] of purifying the obtained ITO particles.

Step (III)

The step (III) is a step of, after a completion of the dropwise addition of the precursor solution in the step (II), retaining the obtained reaction solution under a heating temperature condition, without immediately cooling the obtained reaction solution.

The temperature of the reaction solution may be maintained in the above-described preferred heating temperature range, for example, 230° C. to 320° C. It is not necessary to be retained at a constant temperature during the retention time, and according to the above-described example of the preferred temperature range, the temperature may be initially set to 230° C. and gradually raised, or may be lowered from 320° C. In addition, in a case of using a reaction vessel equipped with a temperature adjusting mechanism, it is sufficient that the temperature of the reaction solution is maintained within a range of 230° C. to 320° C. even in a case of some temperature fluctuation.

The reaction temperature (temperature of the reaction solution) in the step (II) and the retention temperature in the step (III) may be the same as or different from each other.

The retention temperature of the reaction solution is preferably in a range of 230° C. to 320° C., more preferably 250° C. to 310° C., and still more preferably 280° C. to 300° C.

The time for retaining the reaction solution at the above-described temperature is preferably 10 minutes or more, and more preferably 20 minutes or more. The upper limit of the retention time may be 180 minutes or less.

By retaining the reaction solution in the above-described temperature range for a certain period of time, ITO particles having more stable physical properties are obtained even in a case where the dropping rate during the reaction is increased.

Step (IV)

The step (IV) is a step of purifying the ITO particles obtained through the step (II).

The ITO particles obtained through the step (II) are obtained in a state of being dispersed in the solvent. Therefore, the step (IV) of purifying the ITO particles may be performed by, for example, subjecting the ITO particles dispersed in the reaction solution to centrifugation by adding ethanol so as to precipitate the particles, removing the supernatant, and redispersing the ITO particles in toluene.

The step (IV) of purifying the ITO particles may be repeated a plurality of times as necessary. In the above, ethanol is used as the solvent for precipitating the particles, and toluene is used as the solvent for washing. However, the solvents may be appropriately selected depending on the purpose.

The ITO particles obtained by the producing method according to the embodiment of the present disclosure can be suitably used for an optical filter in the near infrared region, an optical lens material using wavelength dispersion, and the like.

The content of indium and the content of tin in the obtained ITO particles are measured by inductively coupled plasma (ICP) mass spectrometry.

Hereinafter, a method for producing a curable composition including the ITO particles obtained by the producing method according to the embodiment of the present disclosure will be described.

Method for Producing Curable Composition

The curable composition according to the embodiment of the present disclosure is a composition including the above-described ITO particles according to the embodiment of the present disclosure and the polymerizable compound, and is a composition cured by applying energy from external.

The method for producing the curable composition including the indium tin oxide particles obtained by the producing method according to the embodiment of the present disclosure is not particularly limited, and a known method for producing a curable composition can be appropriately applied. Among these, it is preferable to produce the curable composition by the method for producing a curable composition according to the embodiment of the present disclosure described below.

The method for producing a curable composition according to the embodiment of the present disclosure includes a step (first step) of obtaining indium tin oxide particles by the above-described producing method according to the embodiment of the present disclosure, and a step (second step) of obtaining a curable composition having absorption in a near infrared region by mixing the obtained indium tin oxide particles and a polymerizable compound.

As described above, since the ITO particles obtained by the producing method according to the embodiment of the present disclosure has a peak wavelength of a plasmon resonance absorption in the near infrared region (for example, a wavelength near 1900 nm, preferably a wavelength of 1800 nm or less), a curable composition having a low Abbe number can be realized, which leads to improvement in performance in a case of being used as a diffraction grating lens and improvement in degree of freedom in a case of designing an optical element.

First Step in Method for Producing Curable Composition

The method for producing ITO particles, which is a first step in the method for producing a curable composition according to the embodiment of the present disclosure, is the same as the above-described producing method of ITO particles according to the embodiment of the present disclosure, and the preferred aspects are also the same.

In the first step, since the ITO particles obtained in a state of being dispersed in the solvent are in a state of being dispersed in the reaction solution, a step of purifying the ITO particles may be performed by, for example, subjecting the ITO particles dispersed in the reaction solution to centrifugation by adding ethanol so as to precipitate the particles, removing the supernatant, and redispersing the ITO particles in toluene. The step of purifying the ITO particles may be repeated a plurality of times as necessary.

Second Step in Method for Producing Curable Composition

The method for producing a curable composition according to the embodiment of the present disclosure has, as a second step, a step of mixing the obtained indium tin oxide particles and a polymerizable compound. By the mixing, a curable composition having absorption in the near infrared region is obtained.

The method of mixing the indium tin oxide particles and the polymerizable compound is not particularly limited. It is preferable that the indium tin oxide particles and the polymerizable compound are stirred and mixed until no separation is visually observed and a uniform mixture is obtained.

In the second step, in a case of mixing the ITO particles and the polymerizable compound, the amount of ITO particles to be used, amount of polymerizable compound to be used, amount of optional components which can be used, and the like are the same as those in the above-described curable composition according to the embodiment of the present disclosure, and preferred examples thereof are also the same.

In the present disclosure, the “total solid content” refers to the total amount of components in the composition, excluding volatile components such as a solvent.

The content of the ITO particles in the curable composition can be calculated, in a case where the composition is subjected to a thermal mass spectrometry and remaining solid components after heating to a temperature (for example, 500° C.) at which liquid components can be completely removed are regarded as ITO particles, as a mass content of the ITO particles with respect to the total solid content of the curable composition to be measured.

Characteristics of Curable Composition

According to the method for producing a curable composition according to the embodiment of the present disclosure, a curable composition useful for an optical member can be efficiently obtained.

### EXAMPLES

Hereinafter, the ITO particles and the like according to the embodiment of the present disclosure will be described in more detail with reference to Examples. However, the present disclosure is not limited to the following examples as long as it does not depart from the scope of the present disclosure. In addition, “parts” and “%” are on a mass basis unless otherwise specified. “mL” refers to milliliter.

### Example 1

First, 125 mL (396 mmol) of oleic acid (manufactured by FUJIFILM Wako Pure Chemical Corporation; purity: 65.0% or more), 25.151 g (86 mmol) of indium acetate (manufactured by Alfa Aesar, 99.99%), and 2.697 g (7.6 mmol) of tin (IV) acetate (manufactured by Alfa Aesar) were added in a flask, and the mixture was heated for 2 hours under a temperature condition of 160° C. in an environment of nitrogen flow to obtain a yellow transparent precursor solution [step (I)].

As a result of analysis, it was confirmed that the above-described commercially available oleic acid [reagent] used in Example 1 was a mixture which contained, with respect to the total amount of the reagent, 82.5% of oleic acid, 10.6% of linoleic acid, 4.9% of palmitic acid, and 1.8% of stearic acid, and had a total content ratio of carboxylic acids having 6 to 20 carbon atoms of 99% or more.

The ratio of the total metal content to the carboxylic acid in the precursor solution obtained in the step (I) was as follows, and satisfied the above-described expressions 2 and 3.

B/A was 4.2 (molar basis).

Subsequently, 225 mL of oleyl alcohol (724 mmol as a solvent having a hydroxyl group and having 14 to 22 carbon atoms) (manufactured by FUJIFILM Wako Pure Chemical Corporation; purity: 65.0% or more) was added to another flask, and heated at 285° C. in a nitrogen flow. Using a syringe pump, 125 mL of the precursor solution obtained in the step (I) was added dropwise to the heated solvent at a rate of 1.17 mL/min [step (II)].

As a result of analysis, it was confirmed that the above-described commercially available oleyl alcohol [reagent] used in Example 1 was a mixture which contained, with respect to the total amount of the reagent, 93.0% of oleyl alcohol, 4.6% of hexadecanol, and 2.4% of octadecadienol. From the molar amount estimated from the average molecular weight, the molar amount of the solvent having a hydroxyl group and having 14 to 22 carbon atoms was calculated.

The relationship between the total content of the carboxylic acid in the reaction solution of the step (II) and the content of the solvent having a hydroxyl group and having 14 to 22 carbon atoms was as follows, and satisfied the above-described expression 4.

D/(C+D)=0.35 (molar basis)

After the completion of the dropwise addition of the precursor solution in the step (II), the obtained reaction solution was retained at 285° C. for 30 minutes [step (III)]. Thereafter, the heating was stopped and the reaction solution was cooled to room temperature.

The obtained reaction solution was subjected to centrifugation so as to remove the supernatant, and redispersed in toluene. The ethanol addition, centrifugation, removal of the supernatant, and toluene redispersion were repeated three times to obtain a toluene dispersion of indium tin oxide particles coordinated with oleic acid [step (IV)].

In a case where the indium tin oxide particles were observed with a transmission electron microscope (TEM) and an equivalent circular size of 100 particles was calculated to obtain an arithmetic average value thereof, the number-average particle size was 21 nm.

In a case where the above-described toluene dispersion of the indium tin oxide particles was diluted and the absorption spectrum was measured by the above-described method, it was confirmed that a clear plasmon resonance absorption peak was present near 1750 nm.

Subsequently, a treatment of subjecting the obtained reaction solution to centrifugation by adding ethanol so as to precipitate particles, removing the supernatant, redispersing the particles in toluene was repeated 3 times to obtain a toluene dispersion of indium tin oxide particles coordinated with oleic acid.

In a case where the indium tin oxide particles were observed with a transmission electron microscope (TEM) and an equivalent circular size of 100 particles was calculated to obtain an arithmetic average value thereof, the number-average particle size was 21 nm.

### Comparative Example 1

A precursor solution was prepared with the amount of oleic acid used in the step (I) of Example 1 being 187.5 mL (594 mmol).

In Comparative Example 1, the ratio of the total metal content to the carboxylic acid in the obtained precursor solution was as follows, and did not satisfy the above-described expression 2.

B/A=6.3

Using the obtained precursor solution, a toluene dispersion of indium tin oxide particles was obtained in the same manner as in Example 1, except that the dropping rate of the precursor solution was 1.75 mL/min.

In a case where the indium tin oxide particles were observed with a transmission electron microscope (TEM) and an equivalent circular size of ITO particles was calculated in the same method as in Example 1 to obtain an arithmetic average value thereof, the number-average particle size was 28 nm.

In a case where the above-described toluene dispersion of the indium tin oxide particles was diluted and the absorption spectrum was measured by the above-described method, it was confirmed that a clear plasmon resonance absorption peak was present near 1750 nm.

Evaluation

—Linear Transmittance of Visible Light—

The toluene dispersions of indium tin oxide particles of Example and Comparative Example were diluted with toluene to 0.6% by mass, and the linear transmittance of visible light at the following wavelengths was measured using an optical cell having an optical path length of 0.2 cm. The results are shown in Table 1 below.

Haze

To measure the haze, the ITO particle dispersion was dried to remove the non-polar solvent, and the concentration [% by mass] of solid contents of the dispersion was obtained. Thereafter, a dispersion obtained by diluting the concentration of solid contents of the dispersion system to 0.6% by mass was prepared and used as a solution to be measured.

A spectroscopic haze meter (manufactured by NIPPON DENSHOKU INDUSTRIES Co., Ltd., SH7000) was used to evaluate the haze value of the obtained solution to be measured. The results are shown in Table 1 below.

TABLE 1

| | Linear | Linear | Linear | |
|---|---|---|---|---|
| | transmittance | transmittance | transmittance | Haze |
| | @λ = 360 nm | @λ = 380 nm | @λ = 400 nm | value |
| Example 1 | 72.3 | 81.3 | 85.1 | 0.6 |
| Comparative | 64.5 | 77.2 | 83.8 | 1.1 |
| Example 1 | | | | |

From the results in Table 1, it was confirmed that the ITO particle dispersion obtained by the producing method of Example 1 had a high linear transmittance and a low haze value associated therewith.

XPS Analysis of ITO Particles

The X-ray photoelectron spectroscopy spectrum evaluation of the ITO particles obtained in Example 1 and Comparative Example 1 was performed using an XPS analyzer. An XPS analyzer (manufactured by PHI, Quantera SXM: device name) was used to evaluate the bonding state of oxygen atoms on an outermost surface of ITO particles under the following conditions.

[Conditions]
X-ray source: monochromatic Al (1486.6 eV)
Detection depth: 4 to 5 nm (extraction angle: 45°)

As a method of peak separation, the oxygen amount O_{A} attributed to a peak having a peak top at a position of 530.0±0.5 eV and the oxygen amount O_{B} attributed to a peak having a peak top at a position of 531.5±0.5 eV were estimated by the area value of each peak in oxygen is spectrum.

The area value of each peak can be calculated by performing waveform separation by peak fitting of the oxygen is spectrum, and in the present disclosure, the value calculated by the above method was used. The results are shown in Table 2 below.

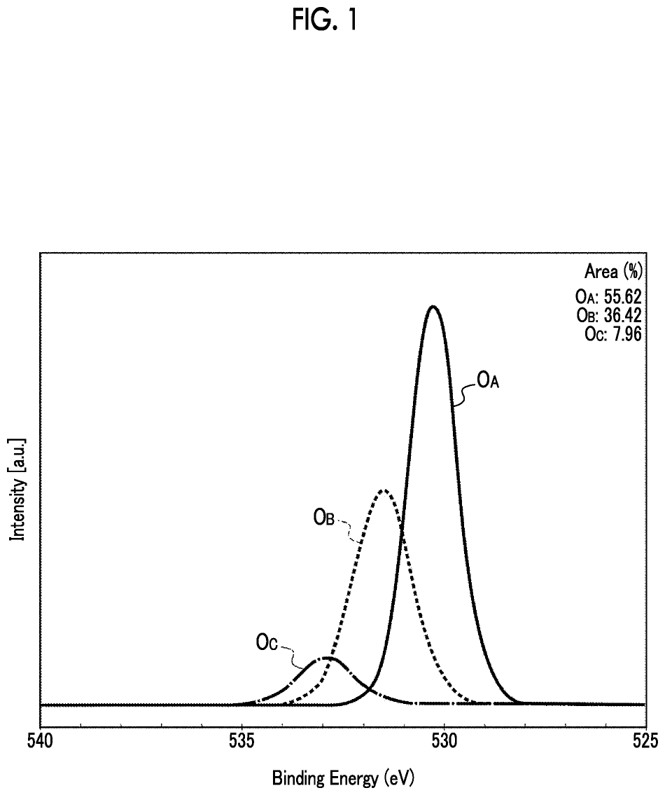

In addition, the XPS spectrum of the ITO particles obtained in Example 1 is shown in FIG. 1.

TABLE 2

| | O_{A} | O_{B} | O_{A}/O_{B} |
|---|---|---|---|
| Example 1 | 55.6 | 36.4 | 1.53 |
| Comparative Example 1 | 52.4 | 37.9 | 1.38 |

As shown in Table 2, in the ITO particles obtained by the producing method of Example 1, the ratio (O_{A}/O_{B}) of the oxygen amount O_{A} attributed to a peak having a peak top at a position of 530.0±0.5 eV to the oxygen amount O_{B} attributed to a peak having a peak top at a position of 531.5±0.5 eV was 1.53, and satisfied the above-described expression 1. On the other hand, in the ITO particles obtained by the producing method of Comparative Example 1, the ratio was 1.38, which was outside of the range of the above-described expression 1. From this, it can be seen that the ITO particles obtained in Example 1 have a better bonding state between oxygen atoms and metal atoms on the particle surface than the ITO particles obtained in Comparative Example 1.

### Example 2

—Production of Curable Composition—

41.4 μL of DISPERBYK-111 (manufactured by BYK Japan KK) was added, as a dispersant, to the toluene dispersion (ITO particles content: 480 mg) of indium tin oxide particles (ITO particles) obtained in Example 1, 467.3 μL of 1,6-hexanediol diacrylate was further added thereto as a polymerizable compound, and the mixed solution was stirred with a hot stirrer at 40° C. for 1 hour (second step).

The toluene solvent was removed from the obtained mixed solution using an evaporator to obtain an ITO particle-containing curable composition in which the ITO particles were dispersed in the polymerizable compound.

The content of the ITO particles in the ITO particle-containing curable composition was 50% by mass with respect to the total solid content of the composition.

The obtained ITO particle-containing curable composition was evaluated using a refractometer DR-M2 (manufactured by ATAGO CO., LTD.). That is, using the toluene dispersion of ITO particles in Example 1, the curable composition including ITO particles was produced according to the above-described method, and the Abbe number of the curable composition were evaluated.

The Abbe number ν_{d} was 17.7.

The Abbe number is an index indicating the wavelength dispersion of the refractive index in the visible light region, and the Abbe number ν_{d} is calculated by the following equation.

ν_{d}=(n_{d}−1)/(n_{f}−n_{c})
n_{d}: refractive index of d line (587.6 nm)
n_{f}: refractive index off line (486.1 nm)
n_{c}: refractive index of c line (656.3 nm)

The C line, D line, and F line are the C line, D line, and F line in the Fraunhofer line.

The curable composition including the ITO particles obtained by the producing method of Example 1 had an Abbe number (ν_{d}) of 17.7 and an n_{d} of 1.502, and had a large wavelength dispersion. In a case where the curable composition has a low Abbe number, it can be expected that a cured product of the curable composition also has a low Abbe number.

Therefore, in a case where the curable composition is used as a diffraction grating, the height of the diffraction grating can be lowered, and it is possible to significantly reduce the occurrence of flare. Therefore, the ITO particles and curable composition obtained by the producing method according to the embodiment of the present disclosure can be suitably used for various uses such as an optical member.

### Example 3

A toluene dispersion of ITO particles was obtained in the same method as in Example 1, except that, in Example 1, the amount of oleic acid added was changed from 125 mL (396 mmol) to 145 mL (460 mmol).

The ratio of the total metal content to the carboxylic acid in the precursor solution obtained in the step (I) was as follows, and satisfied the above-described expressions 2 and 3.

B/A was 4.9 (molar basis).

### Example 4

A toluene dispersion of ITO particles was obtained in the same method as in Example 1, except that, in Example 1, the amount of oleic acid added was changed from 125 mL (396 mmol) to 104 mL (330 mmol).

The ratio of the total metal content to the carboxylic acid in the precursor solution obtained in the step (I) was as follows, and satisfied the above-described expressions 2 and 3.

B/A was 3.5 (molar basis).

### Example 5

A toluene dispersion of ITO particles was obtained in the same method as in Example 1, except that, in Example 1, the dropping rate of the precursor solution obtained in the step (I) was changed from 1.17 mL/min to 0.75 mL/min.

With regard to the ITO particle dispersions obtained by the producing methods of Examples 3 to 5, the linear transmittance and the haze value were measured in the same manner as in Example 1. The results are shown in Table 3.

TABLE 3

| | Linear | Linear | Linear | |
|---|---|---|---|---|
| | transmittance | transmittance | transmittance | Haze |
| | @λ = 360 nm | @λ = 380 nm | @λ = 400 mn | value |
| Example 3 | 71.3 | 80.8 | 84.9 | 0.8 |
| Example 4 | 72.4 | 81.4 | 85.0 | 0.6 |
| Example 5 | 72.4 | 81.5 | 85.2 | 0.6 |

From the results in Table 3, it was confirmed that the ITO particle dispersions obtained by the producing method of Examples 3 to 5 had a high linear transmittance and a low haze value associated therewith.

### Example 6

The polymerizable composition obtained in Example 2 was formed into a film, and the obtained polymerizable composition film was cured by irradiating the obtained polymerizable composition film with ultraviolet rays at an exposure energy of 30 mW/cm² for 30 seconds using a metal halide lamp, thereby obtaining a cured film having a thickness of 6 μm.

With regard to the obtained cured film of the curable composition including ITO particles, the Abbe number was evaluated by the above-described method.

The cured product of the curable composition including the ITO particles obtained by the producing method of Example 6 had an Abbe number (ν_{d}) of 18.8 and an n_{d} of 1.532, and had a large wavelength dispersion.

From this result, in a case where the cured film of the curable composition of Example 6 is used as a diffraction grating, it can be seen that the height of the diffraction grating can be lowered, and it is possible to significantly reduce the occurrence of flare. Therefore, it can be seen that the cured product of the curable composition including the ITO particles obtained by the producing method according to the embodiment of the present disclosure can be suitably used for various uses such as an optical member. cm What is claimed is:

1. An indium tin oxide particle comprising: in an X-ray photoelectron spectroscopy spectrum,
an oxygen amount O_{A} attributed to a peak having a peak top at a position of 530.0±0.5 eV; and
an oxygen amount O_{B} attributed to a peak having a peak top at a position of 531.5±0.5 eV,
wherein the oxygen amount O_{A} and the oxygen amount O_{B} satisfy the following expression 1,
O_{A}/O_{B}>1.4: Expression 1.

2. An indium tin oxide particle dispersion comprising:
the indium tin oxide particle according to claim 1; and
a non-polar solvent.

3. A curable composition comprising:
the indium tin oxide particle according to claim 1; and
a polymerizable compound.

4. The curable composition according to claim 3,
wherein the polymerizable compound includes at least one selected from the group consisting of a monomer unit derived from acrylic acid and a monomer unit derived from methacrylic acid.

5. An optical member which is a cured product of the curable composition according to claim 3.

6. A lens unit comprising:
the optical member according to claim 5.

7. A method for producing indium tin oxide particles, the method comprising:
obtaining a precursor solution including indium and tin by heating a mixed solution including indium carboxylate having 1 to 3 carbon atoms, tin carboxylate having 1 to 3 carbon atoms, and a solvent including a carboxylic acid having 6 to 20 carbon atoms, within a range in which a total amount A mol of indium and tin included in the indium carboxylate and the tin carboxylate, and a content B mol of the carboxylic acid included in the solvent satisfy the following expression 2; and
obtaining a reaction solution including indium tin oxide particles by adding dropwise the obtained precursor solution to a heated solvent having a hydroxyl group and having 14 to 22 carbon atoms,
B/A<5: Expression 2.

8. The method for producing indium tin oxide particles according to claim 7,
wherein the total amount A mol of indium and tin included in the indium carboxylate and the tin carboxylate, and the content B mol of the carboxylic acid included in the solvent satisfy the following expression 3,
3<B/A: Expression 3.

9. The method for producing indium tin oxide particles according to claim 7,
wherein, in obtaining the reaction solution including the indium tin oxide particles, the precursor solution is added dropwise at a dropping rate of 1.0 mL/min or more.

10. The method for producing indium tin oxide particles according to claim 7,
wherein the carboxylic acid having 6 to 20 carbon atoms includes oleic acid.

11. The method for producing indium tin oxide particles according to claim 7,
wherein the solvent having a hydroxyl group and having 14 to 22 carbon atoms includes oleyl alcohol.

12. The method for producing indium tin oxide particles according to claim 7,
wherein a temperature of the heated solvent having a hydroxyl group and having 14 to 22 carbon atoms is 230° C. to 320° C.

13. The method for producing indium tin oxide particles according to claim 7,
wherein a total content C mol of the solvent having a hydroxyl group and having 14 to 22 carbon atoms, and a content D mol of the carboxylic acid having 6 to 20 carbon atoms satisfy the following expression 4,
D/(C+D)<0.5: Expression 4.

14. A method for producing a curable composition, the method comprising:
obtaining indium tin oxide particles by the method for producing indium tin oxide particles according to claim 7; and
obtaining a curable composition having absorption in a near infrared region by mixing the obtained indium tin oxide particles and a polymerizable compound.

15. The indium tin oxide particle according to claim 1,
which comprises a plurality of indium tin oxide particles having a number-average particle size of 10 nm to 30 nm.

16. The curable composition according to claim 3, further comprising a dispersant.

17. The curable composition according to claim 3,
wherein the polymerizable compound is a polyfunctional (meth)acrylate compound.
